(19) United States
(12) Patent Application Publication
(10) Pub. No.: US 2024/0069531 A1
(43) Pub. Date: Feb. 29, 2024

(54) INDUSTRIAL INTERNET OF THINGS DATA INTEGRATION

(71) Applicant: Ivanti, Inc., South Jordan, UT (US)

(72) Inventors: Travis Peters, South Jordan, UT (US); David Brugneaux, Évry (FR); Laurent Gabardos, Saint-Fargeau-Ponthierry (FR); Ian Hughes, Greater Cheshire West (GB)

(73) Assignee: Ivanti, Inc., South Jordan, UT (US)

(21) Appl. No.: 18/458,610

(22) Filed: Aug. 30, 2023

Related U.S. Application Data
(60) Provisional application No. 63/374,098, filed on Aug. 31, 2022.

(51) Int. Cl. G05B 19/418

(52) U.S. Cl. CPC G05B 19/41855

(57) ABSTRACT

A method may include obtaining a first sensor input signal and converting the first sensor input signal to a second sensor input signal having a common data format based on one or more data conversion rules. The method may include appending the second sensor input signal with a variable that describes information relating to the first sensor input signal. The method may include broadcasting the second sensor input signal in the common data format to one or more data storages and sending an instruction to actuate warehouse operations to one or more receiving systems based on the one or more data storages to which the second sensor input signal is broadcast. The method may include controlling one or more operations of a warehouse based on the instruction to actuate warehouse operations.

### CROSS-REFERENCE TO RELATED APPLICATION

This application claims priority to and the benefit of U.S. Provisional Application No. 63/374,098 filed Aug. 31, 2022, which is incorporated herein by reference in its entirety.

### FIELD

The present disclosure relates to industrial internet of things (IIOT). Some embodiments relate to IIOT data integration with receiving systems.

### BACKGROUND

Internet of Things (IoT) devices are physical objects, such as consumer appliances, which include sensors, associated software, and communicative connectivity with computer systems or other devices via the Internet or other computer networks. IoT devices may further include industrial devices or objects, such as manufacturing machines, warehouses, and other storage facilities. Such industrial IoT devices may be configured to communicate with a central computer system, other industrial IoT devices, or users in the industrial system to receive input regarding how to perform operations relating to the industrial system.

However, existing systems that implement industrial IoT devices may capture data from the industrial devices or objects in a wide variety of different formats. Because incoming sensor data from the industrial IoT devices may include different formats, a computer system configured to receive and analyze the sensor data may not be capable of interpreting sensor data including particular formats. The computer system may consequently only be able to integrate with a limited selection of industrial IoT devices, and sensor data from some industrial IoT devices may not be considered in industrial analyses by the computer system.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method of industrial internet of things (IIOT) data conversion and distribution. The method may include obtaining a first sensor input signal and converting the first sensor input signal to a second sensor input signal having a common data format based on one or more data conversion rules. The method may include appending the second sensor input signal with a variable that describes information relating to the first sensor input signal. The method may include broadcasting the second sensor input signal in the common data format to one or more data storage locations and sending an instruction to actuate warehouse operations to one or more receiving systems based on the one or more data storage locations to which the second sensor input signal is broadcast. The method may include controlling one or more operations of a warehouse based on the instruction to actuate warehouse operations.

Another aspect of an embodiment includes a non-transitory computer-readable medium having encoded therein programming code executable by one or more processors to perform or control performance of any combination of the operations of the method of IIOT data conversion and distribution described above.

Yet another aspect of an embodiment includes a computing device comprising one or more processors and a non-transitory computer-readable medium having encoded therein programming code executable by one or more processors to perform or control performance of any combination of the operations of the method of the method of IIOT data conversion and distribution described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is an example embodiment of an operating environment configured to process signal data relating to industrial Internet of Things (IIOT) devices and industrial operations according to at least one embodiment of the present disclosure;

FIG. 2 is a detailed diagram of an example embodiment of the IIOT system of the operating environment according to at least one embodiment of the present disclosure;

FIG. 3 is a flowchart of an example method of processing signal data relating to IIOT devices and industrial operations according to at least one embodiment of the present disclosure; and

FIG. 4 is an example computing system configured according to at least one embodiment of the present disclosure, all in accordance with at least one embodiment of the present disclosure.

### DETAILED DESCRIPTION

Industrial Internet of Things (IIOT) devices may include sensors and devices deployed in an industrial environment. The IIOT devices may be interconnected with a computing system that analyzes data and information captured by the IIOT devices during one or more industrial processes. The computer system may process, analysis, and implement system controls based at least partially on the data and information captured by the IIOT devices. For instance, the computer system may determine, in real time, operations for the industrial processes based on the data communicated from the IIOT devices periodically or on a continual basis. Deployment of IIOT devices along with the computing system may accordingly improve control of the industrial processes. For instance, the IIOT devices may facilitate identification and reduction of unproductive operator behaviors, quality control improvement, and increase efficiency in an industrial process.

However, existing IIOT devices may be configured to obtain and communicate data in a date format type that is incompatible with some computing systems. The computer systems configured to process and analyze the data captured by the IIOT devices may not be compatible with one or more data format types. In such situations, the computer system may be forced to omit data obtained from IIOT devices. The analysis provided by the computer system may be incomplete because of the omitted data, which may cause instructions provided by the computer system or a corresponding control system to be inaccurate or even detrimental to industrial operations.

The present disclosure relates to, among other things, a computer system configured to obtain and process signal data relating to industrial operations. The computer system may obtain signal data and convert the signal data to a common data format, which may be stored such that it may be used by one or more receiving systems. The receiving systems may be configured to control industrial operations, such as a warehouse operation control system. The receiving systems may retrieve the stored signal data at a defined or specific location and generate instructions based on the retrieved signal data. The common data format may enable a larger range of data use. Additionally, as the signal data is updated at the specific locations, the receiving system may retrieve the updated signal data, which may enable real time or substantially real time controls of the industrial operations. Moreover, the multiple receiving systems, which may be different and operate according to different protocols, may access the updated signal data. The common data may enable these multiple receiving systems to access and use the common data.

Controlling industrial operations according to the present disclosure may improve IIOT devices and industrial operations by allowing various systems configured to control the industrial operations to provide more nuanced or effective instructions to the industrial system according to more efficiently collected or sorted sensor signals. Additionally, the converted signal data may improve machine-learning processes and artificial intelligence systems by providing unbiased and uniformly formatted data for the machine-learning processes and artificial intelligence systems.

In the foregoing description and the detailed descriptions of the figures below, the term “industrial” when describing Internet of Things (IoT) devices or operations refers to IoT devices, operations, or processes relating to manufacturing, supply chain, or management systems rather than for consumer usage. For example, an industrial operation may refer to an operation used in a product manufacturing process, a supply chain (i.e., trucking transportation or warehouse processes), or management of such processes.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

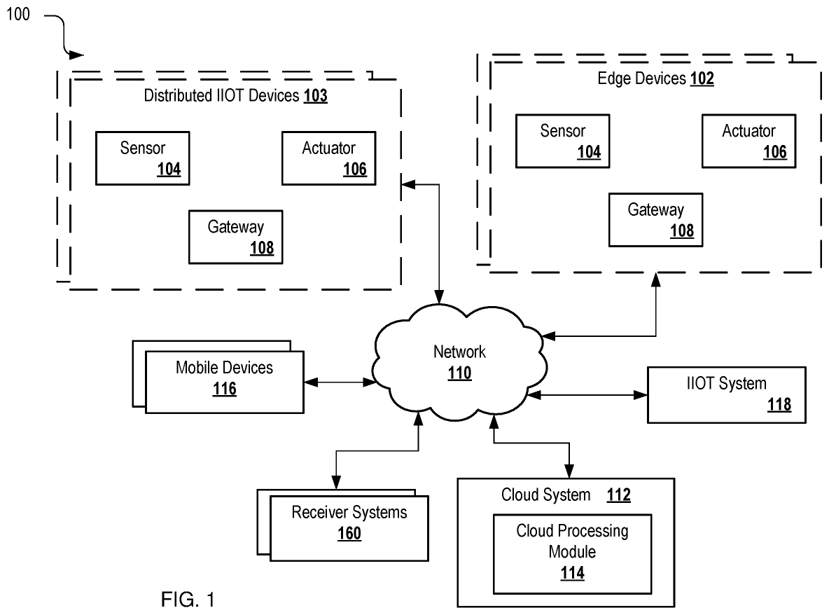

FIG. 1 is an example operating environment 100 configured to process signal data relating to IIOT devices and industrial operations. The operating environment 100 may include a cloud system 112 that is configured to communicate data and information with edge devices 102, distributed IIOT devices 103, and mobile devices 116. The data and information communicated in the operating environment 100 may be related to operations of an IIOT system 118. The IIOT system 118 may involve control systems, sensors, or operational components that affect or monitor product manufacturing processes, product assembly lines, supply chain operations (e.g., movement of products into, out of, or within a warehouse), or another similar industrial process.

The operating environment 100 may include edge devices 102, the distributed IIOT devices 103, the IIOT system 118, the mobile devices 116, the receiver systems 160, and the cloud system 112 (collectively, “environment components”). The environment components may communicate via a network 110. Each of the environment components are introduced in the following paragraphs.

The network 110 may include one or more wide area networks (WANs) and/or local area networks (LANs) that enable the edge devices 102, the distributed IIOT devices 103, the cloud system 112, the mobile devices 116, and the IIOT system 118 to communicate with each other. In some embodiments, the network 110 may include the Internet in which communicative connectivity between the edge devices 102, the distributed IIOT devices 103, the cloud system 112, the mobile devices 116, and the IIOT system 118 is formed by logical and physical connections between multiple WANs and/or LANs. Additionally or alternatively, the network 110 may include one or more cellular radio frequency (RF) networks, one or more wired networks, one or more wireless networks (e.g., 802.xx networks), Bluetooth access points, wireless access points, Internet Protocol (IP)-based networks, or any other wired and/or wireless networks. The network 110 may also include servers that enable one type of network to interface with another type of network.

The operating environment 100 may include the edge devices 102. The edge devices 102 may be communicatively coupled with the environment components via the network 110. The edge devices 102 may include a sensor 104, an actuator 106, a gateway 108, or some combination thereof. In some embodiments, the edge devices 102 may include computer systems that facilitate sending or receiving data between two or more networks such that the edge devices 102 may function as entry points or exit points to the networks. For example, the edge devices 102 may include routers, routing switches, multiplexers, wide area network access devices, integrated access devices, any other networking devices, or some combination thereof.

The operating environment 100 may include the distributed IIOT devices 103. Like the edge devices 102, the IIOT devices 103 may include the sensor 104, the actuator 106, the gateway 108, or some combination thereof. The distributed IIOT devices 103 may be communicatively coupled with the environment components via the network 110. In some embodiments, the distributed IIOT devices 103 may include a hardware-based device that is configured to collect sensor data from or about an industrial operation and send the collected sensor data to one or more computer systems such as the environment components of FIG. 1. For example, the distributed IIOT devices 103 may include a temperature-control system, a camera system, a pressure sensor, a weight scale, an operator terminal, another suitable control-sensor system or device, or combinations thereof.

The sensors 104 may include a hardware-based device used in an industrial process. The sensors 104 may collect data or measure one or more physical properties related to the industrial process. For example, the sensors 104 may include a camera, which may be located in a warehouse or another industrial environment. The camera may be configured to capture images of product quantities included in the warehouse, locations of warehouse operators, movement of products within the warehouse, other warehouse operations, or combinations thereof. As another example, the sensors 104 may include or relate to a conveyor belt implemented in a manufacturing process. The sensors 104 may detect physical phenomena such as a weight of an object placed on the conveyor belt, a quantity of objects passing through the conveyor belt, an identity of an object on the conveyor belt, or combinations thereof. As another example, the sensors 104 may include a button or key that may be pressed. In this example, a frequency and/or a duration of the button or key being pressed or otherwise actuated may be captured.

The actuators 106 may implement or initiate a physical operation of one or more of the edge devices 102 or the distributed IIOT devices 103. The actuators 106 may implement or initiate the physical operation based on a received signal relating to control of a device. In some embodiments, the actuators 106 may be communicatively coupled to the gateways 108 to receive control signal data relating to device operations. For instance, the control signal data may be received from the cloud system 112, the IIOT system 118, one or more of the mobile devices 116, or combinations thereof. Additionally or alternatively, the actuators 106 may receive control signal data from the sensors 104 or from a processing unit on the edge devices 102 or the distributed IIOT devices 103. The control signal from the processing unit may be based at least partially on signal data from the sensors 104.

The edge devices 102 and the distributed IIOT devices 103 may be configured to communicate with one or more of the mobile devices 116, the cloud system 112, and the IIOT system 118 via the gateway 108. In some embodiments, the gateway 108 may facilitate routing data collected by the sensors 104 to the IIOT system 118, the cloud system 112, one or more of the mobile devices 116, or combinations thereof. Additionally or alternatively, data and information sent by the IIOT system 118, the cloud system 112, and one or more mobile devices 116 may be configured to communicate information to the edge devices 102 and the distributed IIOT devices 103 via one of the gateways 108.

In some embodiments, the gateway 108 may be configured to direct signal data from the edge device 102 and the distributed IIOT devices 103 to the cloud system 112, the IIOT system 118, the mobile devices 116, other edge devices 102, or other distributed IIOT devices 103 via the network 110. For instance, the gateway 108 of a first distributed IIOT device 103 may be configured to send data captured by the sensor 104 of the first distributed IIOT device 103 along a first channel via the network 110 to one or more of the environment components.

In some embodiments, the edge devices 102 and/or the distributed IIOT devices 103 may be virtual devices. Referring to the edge devices 102 and the distributed IIOT devices 103 as “virtual” indicates that signal data are virtually generated rather than being collected by a physical sensor measuring a physical phenomenon. For example, a virtual distributed IIOT device may simulate an operation of the first distributed IIOT device 103 by communicating virtually generated data signal along a first channel to the network 110. As another example, a warehouse may include a stock replenishment system including a physical stock-replenishment button (e.g., one of the distributed IIOT devices 103) and a virtual input mechanism (e.g., another of the distributed IIOT devices 103). Actuation of the stock-replenishment button may communicate a signal along a particular data channel. The signal may indicate that a particular product is to be replenished. Additionally, a warehouse operator may actuate the virtual input related to stock replenishment using one of the mobile devices 116. Actuation of the virtual input may provide a substantially similar signal that indicates the particular product is to be replenished. The substantially similar signal may be communicated via the particular data channel used by the stock replenishment button in some embodiments.

The mobile devices 116 may include a hardware-based computing system such as a portable computing devices used by operators of an industrial operation. For example, an example of the mobile devices 116 may include a rugged scanner device. The rugged scanner device may be used to identify items included in a warehouse, register items during movement in the warehouse, removal of items from the warehouse, or another warehouse and supply chain operations. The mobile device 116 may include a display and a software application that provides information to a user on the display. For instance, the software application may organize information related to an identifier (e.g., a bar code or QR code) scanned by the mobile device 116, which may be organized and communicated to the user on the display.

The mobile device 116 and/or the software application on the mobile device 116 may communicate information with other environment components via the network 110. For example, information and signals provided by the edge devices 102, the cloud system 112, and the IIOT system 118 may dictate information displayed or a sequence of information displayed on the display of the mobile device 116. In these and other embodiments, the information received by the mobile device 116 may include instructions to guide a warehouse operator using the mobile device 116, data about the warehouse, items included in the warehouse requested by the warehouse operator, or combinations thereof.

The IIOT system 118 may include a hardware-based computing system implemented to communicate the signal data with the edge devices 102, the distributed IIOT devices 103, the mobile devices 116, and the cloud system 112 via the network 110. The IIOT system 118 may obtain sensor data from the sensors 104. The IIOT system 118 may convert the obtained signal data into a common data format. The signal data in the common data format may make the signal data widely available to multiple systems, referred to as receiver systems 160 in the present disclosure. In addition, the IIOT system 118 may organize the signal data in a common data format such that portions of the signal data are made available at specific locations associated with one or more data storage locations. Accordingly, as the signal data is received and converted by the IIOT system 118, the receiver systems 160 can listen or search at the specific locations of a specific data storage location to gather portions of the converted signal data it uses in an operation.

The receiver systems 160 may include a system that might utilize or implement an operation based at least partially on the signal data obtained in the operating environment 100. The receiver systems 160 are configured to look for a particular subset of the signal data that is published at a particular data storage location. The receiver systems 160 may use the data to monitor or control one or more devices (e.g., the edge devices 102 or the distributed IIOT devices 103) of the operating environment 100.

In the embodiment of FIG. 1, the receiver systems 160 are depicted as separate components. In some embodiments, the receiver systems 160 may include one or more subsystems of the cloud system 112, the mobile devices 116, the IIOT system 118, or combinations thereof. For instance, the receiver systems 160 may be associated with or included in one or more of the mobile devices 116. A user of the mobile device 116 might use the mobile device 116 to monitor or analyze operations of a particular industrial process. The mobile device 116 may be configured to listen to or search a specific data storage location at which a particular subset of converted signal data relating to the industrial process is stored (e.g., inventory levels of a product in a warehouse). The user may prompt the mobile device 116 to listen to the specific data storage location responsive to the user needing information for monitoring or analyzing the industrial process.

In some embodiments, the receiver systems 160 may look to multiple channels for different portions of the converted signal data. For instance, the receiver systems 160 may access a first subset of converted data from a first data storage location and a second subset of converted data from a second data storage location. The receiver system 160 may use the first and the second subset of the converted data in an industrial operation.

The IIOT system 118 may be configured to convert the signal data it obtains to a common data format. For instance, the edge device 102, the distributed IIOT device 103, and the sensor 104 may produce and communicate data signals formatted according to different protocols. The IIOT system 118 may convert the data signals formatted according to different protocols to the common data format.

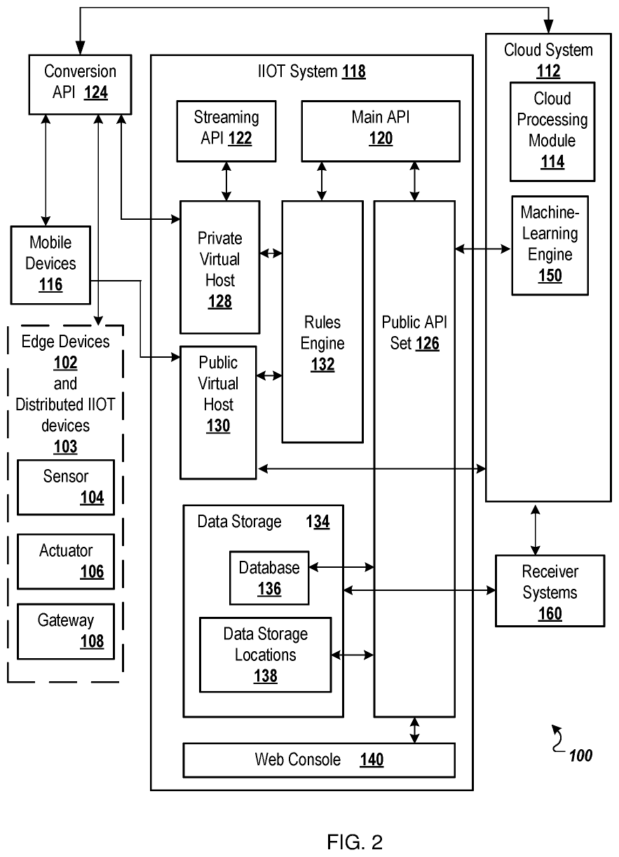

In some embodiments, the IIOT system 118 may be configured to convert the signal data to the common data format as the signal data is obtained. In these and other embodiments, the IIOT system 118 may obtain the signal data and convert the signal data simultaneously or substantially simultaneously. Some additional details of an example conversion process are described with reference to FIG. 2.

In some embodiments, one or more computer systems of the operating environment 100 may be configured to retrieve the commonly formatted signal data from the IIOT system 118 and generate instructions for controlling one or more industrial operations responsive to the retrieved signal data. For example, the edge devices 102, the mobile devices 116, or the cloud system 112 may be configured to query the IIOT system 118 over the network 110 for the commonly formatted signal data stored on the IIOT system 118. Some additional details of a query operation are provided in relation to FIG. 2.

The cloud system 112 may include a hardware-based server. In the embodiment of FIG. 1, the cloud system 112 may include a cloud-based computing system. The cloud system 112 may be based on third-party servers implemented for software platforming, infrastructure, application, storage services, or some combination thereof. For example, the cloud system 112 may be hosted by AMAZON WEB SERVICES®, GOOGLE CLOUD®, MICROSOFT AZURE®, an enterprise server network, or another suitable server provider. In some embodiments, computing resources such as applications, websites, web resources, and data files associated with the IIOT system 118 may be hosted on the cloud system 112. Additionally or alternatively, one or more of the edge devices 102 or the mobile devices 116 may include the computing resources hosted on the cloud system 112. In these and other embodiments, the cloud system 112 may be communicatively coupled with the edge devices 102, the mobile devices 116, and the IIOT system 118 via the network 110.

The cloud system 112 may include a cloud processing module 114. The cloud processing module 114 may be configured to interface the edge devices 102, the distributed IIOT devices 103, the mobile devices 116, the IIOT system 118, or combinations thereof via the network 110.

The cloud processing module 114 may implement one or more cloud-based services, which may be used to input the data obtained by components of the operating environment 100. For instance, the cloud system 112 may support one or more cloud-based services such as application and network management, endpoint management, service management, etc. The cloud-based services may enroll the edge devices 102 and/or the distributed IIOT devices 103 in a managed network. Enrollment of the edge devices 102 and/or the distributed IIOT devices 103 may enable the cloud system 112 to ingest the data and information therefrom. The cloud processing module 114 and the IIOT system 118 enable use of the data by one or more of the cloud-based services. For instance, the cloud processing module 114 may enable endpoint management of devices such as the edge devices 102, the mobile devices 116, and the distributed IIOT devices 103. The data and the signals communicated in the operating environment 100 enable real time status monitoring and control of such devices. Moreover, the cloud-based services may be optimized using the data. For instance, a service management cloud-based service might use the data to verify the physical status of the devices, which might provide insight to physical issues experienced by the devices.

The cloud processing module 114, the IIOT system 118, and components thereof may be implemented using hardware including a processor, a microprocessor (e.g., to perform or control performance of one or more operations), a field-programmable gate array (FPGA), or an application-specific integrated circuit (ASIC). In some instances, the cloud processing module 114, the IIOT system 118, and components thereof may be implemented using a combination of hardware and software.

In the present disclosure, operations described as being performed by the cloud processing module 114 may include operations that the cloud processing module 114 direct via one or more computing systems. The cloud processing module 114 may be configured to perform a series of operations with sensor data captured by the sensors 104, instructions or information relating to the mobile devices 116, information processed by the IIOT system 118, or combinations thereof.

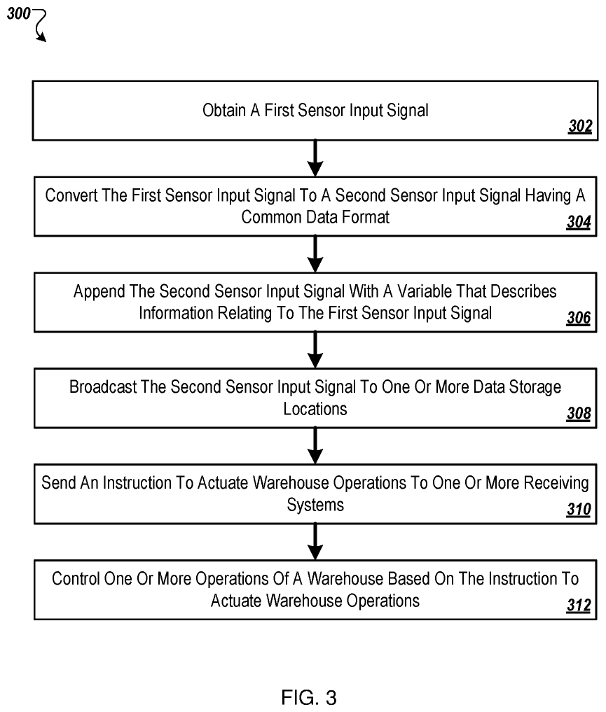

The edge devices 102, the distributed IIOT devices 103, the mobile devices 116, the IIOT system 118, or some combination thereof may be configured to communicate with the cloud processing module 114 and/or the cloud system 112 to perform one or more of the operations associated with the edge devices 102 and the distributed IIOT devices 103. For example, the distributed IIOT devices 103 may be configured to send signal data captured by the distributed IIOT devices 103 to specific data storage locations included with the cloud system 112. As an additional example, the mobile devices 116 or the IIOT system 118 may be configured to send data to or retrieve data from the cloud system 112 to facilitate one or more industrial operations. Some details of an example embodiment of these operations are described with reference to FIG. 3.

Modifications, additions, or omissions may be made to the operating environment 100 without departing from the scope of the present disclosure. For example, the designations of different elements in the manner described is meant to help explain concepts described herein and is not limiting. For instance, in some embodiments, the edge devices 102, the cloud system 112, the mobile devices 116, the IIOT system 118, and the network 110 are delineated in the specific manner described to help with explaining concepts described herein but such delineation is not meant to be limiting. Further, the operating environment 100 may include one or more other elements or may be implemented within other systems or contexts than those described.

FIG. 2 is a block diagram of an example embodiment of the IIOT system 118 of the operating environment 100 according to at least one embodiment of the present disclosure. FIG. 2 presents an example architecture that may be implemented in the IIOT system 118. In some embodiments other architectures may be implemented. FIG. 2 includes some components (e.g., 116, 102, and 112) of FIG. 1. Although not included in FIG. 2, communication described in FIG. 2 may be via a communication network such as the network 110 of FIG. 1. In FIG. 2, double ended arrows indicate communication and data and information between components.

The IIOT system 118 of FIG. 2 includes a main application programming interface (API) 120, a streaming API 122, a public API set 126 (the main API 120, the streaming API 122, and the public API set 126 are collectively referred to as “APIs”), a private virtual host 128, a public virtual host 130, a rules engine 132, data storage 134, and a web console 140. The IIOT system 118 may be communicatively coupled to the edge devices 102, the distributed IIOT devices 103, the mobile devices 116, and the cloud system 112 through one or more of the APIs or the public virtual host 130. For example, the edge devices 102, the distributed IIOT devices 103, the mobile devices 116, or the cloud system 112 may be configured to communicate data with the public virtual host 130. The public virtual host 130 may be configured to communicate with the rules engine 132. Additionally or alternatively, the cloud system 112 or the cloud processing module 114 of the cloud system 112 may be configured to communicate with the IIOT system 118 via the public API set 126.

In some embodiments, the IIOT system 118 may be configured to interface with a conversion API 124. The conversion API 124 may be configured to process signal data generated by and obtained from the sensors 104, the edge devices 102, the distributed IIOT devices 103, the mobile devices 116, or combinations thereof. The conversion API 124 may facilitate connection between applications implemented by the mobile devices 116 and/or the edge devices 102 and a computer system corresponding to the IIOT system 118 to communicate sensor data with the edge devices 102, the distributed IIOT devices 103, and the mobile devices 116.

The conversion API 124 may be configured to obtain sensor data and convert the sensor data between a native data format associated with one or more of the sensors 104 and one or more common data formats. Configuration of the conversion API 124 to parse sensor data may involve generating a mapping between a native data format and one or more of the common data formats. In some embodiments, a driver may be added to a platform core of the IIOT system 118 to generate the mapping (e.g., modifying the core source code associated with the IIOT system 118). Additionally or alternatively, the gateway 108 corresponding to the sensor 104 or an object firmware may be configured such that the sensor data generated by the sensor 104 is reformatted according to the common data formats prior to communication of the sensor data to the conversion API 124 or another component of the IIOT system 118.

In some embodiments, one or more data transformation rules may be created. The data transformation rules may be included with the rules engine 132 of the IIOT system 118. The data transformation rules may facilitate conversion of the sensor data obtained from the edge devices 102, the distributed IIOT devices, the mobile devices 116, or some combination thereof. The rules engine 132 may include scripts, programs, or other source code corresponding to data transformation rules for translating data presented in a first format (e.g., a native or proprietary data format) to a second format (e.g., a common data format associated with the data storage 134). In these and other embodiments, the conversion API 124 may identify a data format associated with incoming sensor data. The conversion API 124 may call a program configured to implement one of the data transformation rules included with the rules engine 132. The call may be implemented via the private virtual host 128. The called data transformation rule may be implemented to convert the incoming sensor data to data having one or more common data formats. The conversion API 124 may send the converted sensor data to the IIOT system 118.

In these and other embodiments, the rules engine 132 may include one or more device templates. The device templates may be configured to identify one or more parameters or characteristics of sensor data. For instance, the device templates may be configured to identify one or more fields of information included in sensor data obtained from a particular (edge or mobile) device type, how to map fields of information to a common data format associated with similar information from other device types, and the like. The device templates may assist with converting multiple different data types including proprietary data formats, to the common data formats used by the IIOT system 118.

Additionally or alternatively, the rules engine 132 may be configured to identify responsive instructions. The responsive instructions may be sent to the cloud system 112, the mobile devices 116, the edge devices 102, or combinations thereof in response to receiving particular types of sensor data or sensor data including particular information.

In some embodiments, a machine learning and/or artificial intelligence system (collectively referred to as a “machine learning system”) and/or a computing module may be implemented as part of the rules engine 132. The machine learning system may facilitate identification of different sensor data triggers. Additionally, the machine learning system may be implemented to determine responsive instructions based on the sensor data triggers.

The converted sensor data may be obtained by the IIOT system 118 via the private virtual host 128. The private virtual host 128 may send the sensor data to the streaming API 122 or the cloud system 112, for instance.

In some embodiments, the converted sensor data may be communicated with the cloud system 112 by the public API set 126. The public API set 126 may include one or more APIs that configure the IIOT system 118 to broadcast converted sensor data to and from the data storage 134, the main API 120, the cloud system 112, or some combination thereof. For instance, the public API set 126 may be configured to broadcast the converted sensor data to a particular database 136 or a particular data storage location 138 included in the data storage 134. The public API set 126 may communicate the converted sensor data to the particular database 136 or the particular data storage location 138 according to characteristics or metadata associated with the sensor data. For instance, the public API set 126 may communicate the converted sensor data to the particular database 136 or the particular data storage location 138 according to an original sensor data format, the common data format of the converted sensor data, a type of industrial operation associated with the sensor data, a type of sensor from which the sensor data was obtained, or another characteristic or metadata associated with the sensor data.

After the converted sensor data are broadcast to data storage locations 138 of the data storage 134, the public API set 126 may facilitate the IIOT system 118 to respond to queries from one or more receiver systems 160. The receiver systems 160 may be communicatively coupled to the IIOT system 118 via the cloud system 112. Additionally or alternatively, the receiver systems 160 may be communicative coupled to the IIOT system 118 via the public virtual host 130 regarding retrieving particular sensor data from the data storage 134. For example, a first mobile device (e.g., one of the mobile devices 116) may be configured to retrieve a first portion of sensor data stored on the IIOT system 118 that includes a first particular common data format at a first data storage location (e.g., an electronic address indicating a specific location in a data storage), while a second mobile device (e.g., another of the mobile devices 116) may be configured to retrieve a second portion of sensor data stored on the IIOT system 118 that includes the first particular common data format at the first data storage location and a second particular common data format at a second data storage location. To retrieve the sensor data from the IIOT system 118, the first mobile device and the second mobile device may interface with the IIOT system 118 via the public virtual host 130 and the cloud system 112. The public virtual host 130 may enable access specific locations (e.g., 138) included in the data storage 134 and retrieval of the first or second portions of sensor data, respectively.

In some embodiments, the receiving systems 160 may be configured to monitor one or more particular databases 136 or data storage locations 138 of the data storage 134. The receiving systems 160 may be notified (e.g., by the IIOT system 118) or configured to detect new or updated sensor data being added to the monitored databases 136 or data storage locations 138. Upon a determination that new or updated sensor data is available, the receiving systems 160 may be configured to receive or access the sensor data. Additionally or alternatively, the receiving systems 160 may be configured to communicate with the cloud system 112 and instruct the cloud system 112 to receive new or updated sensor data, which the receiving systems 160 may then retrieve from the cloud system 112.

In these and other embodiments, selecting the databases 136 or the data storage locations 138 for the receiving systems to monitor may involve the receiving systems subscribing to one or more MQTT topics. The MQTT topics correspond with a MQTT client associated with a particular database 136 or a particular data storage location 138. Returning to the previous example, the first mobile device may be configured to only query a first database that corresponds to a particular MQTT topic to which the first mobile device is subscribed. The second mobile device may be configured to query the first database, a first data storage location, and a second database because the first database, the first data storage location, and the second database each include signal data relating to MQTT topics to which the second mobile device is subscribed. One or more of the databases or locations may include MQTT clients that correspond to one or more MQTT topics to which the second mobile device is subscribed.

An MQTT topic may be an indicator that a computer system may use to filter information accessible to a receiving system, such as the receiver systems 160 and the distributed IIOT devices 103. The computer system may be configured to allow the receiving system to access information corresponding to the MQTT topics to which the receiving system is subscribed while filtering out any information that does not correspond to the subscribed MQTT topics. Accessing information included in the computer system via MQTT topics may provide a lightweight information-access process for the receiving system that uses less processing resources and time than other information-access processes, such as message queueing.

In some embodiments, sensor data corresponding to one or more of the edge devices 102 may be simulated or generated virtually. In these and other embodiments, virtual sensor data not generated based on real-world phenomena may be sent to the IIOT system 118 via the conversion API 124. Because the IIOT system 118 utilizes the common data format, the virtual signal is substantially equivalent to the sensor data. For instance, the receiver system 160 may not be able to distinguish actual sensor data and virtual sensor data that is representative of the actual sensor data.

For example, a warehouse may include a button, which may be an edge device 102 or a distributed IIOT device 103. A warehouse operator may use the button to indicate a need for stock replenishment. Pressing the button may trigger generation of sensor data that indicates a need for stock replenishment (i.e., a binary value equal to one). The sensor data is converted to a particular common data format and stored on the data storage 134 of the IIOT system 118. A first receiver system (e.g., one of the receiver systems 160) related to stocking items in the warehouse may be configured to retrieve sensor data stored on the IIOT system 118. The first receiver system may be configured to process sensor data with the particular common data format. Responsive to a determination that the retrieved sensor data includes a value corresponding to the need for stock replenishment, the first receiving system may implement or trigger implementation of an operation to restock the warehouse. In this example, the sensor data related to the button may be virtualized. For instance, one of the mobile device 116 may include an application configured to generate virtualized sensor data representative of a physical press of the button. A user may use the application to communicate the virtual sensor data representative of the button press. The first receiving system may implement or trigger implementation of the operation to restock the warehouse substantially similarly responsive to the virtualized sensor data.

In some embodiments, the IIOT system 118 or the cloud system 112 may include a machine-learning engine 150. The machine-learning engine 150 may be configured to process the sensor data. The machine-learning engine 150 may determine situations and environmental conditions relating to the industrial operations. For instance, the machine-learning engine 150 may determine situations that result in generation of particular sensor data associated with the edge devices 102 or the distributed IIOT devices 103 and virtually generate representative sensor data.

For example, the warehouse operator may identify that the warehouse needs to replenish the stock of a particular item. The warehouse operator may declare the need for the stock-replenishment via a software application (e.g., a software application on one of the the mobile devices 116). The software application may communicate a signal with the cloud system 112 (i.e., via the conversion API 124 as illustrated in FIG. 2) or the IIOT system 118. The machine-learning engine 150 may determine a correlation between the declaration for the need to restock and an industrial operation of replenishing the stock for the particular action in the warehouse. Based on the determined correlation, the machine-learning engine 150 may virtually generate the sensor data corresponding to pressing the button. Additionally or alternatively, the virtual sensor data may be generated by the machine-learning engine 150 based on other sensor data correlated with the need to replenish an item's stock, such as product weights on one or more warehouse shelves captured by weight sensors, image data of particular sections of the warehouse captured by cameras, or laser scanning data indicating items in a particular section of the warehouse are below a threshold level.

Although described in relation to replenishment of the warehouse stock based on sensor data indicating a particular item's stocking level is below a threshold level, the machine learning system may be configured to virtually generate other types of sensor data for the IIOT system 118 based on multiple types of received sensor data. For example, the machine-learning engine 150 may virtually generate sensor data for contextualizing the stock-replenishment need, such as geolocation data, customer identification information, purchase order information, time of item retrieval, or any other data that may be related to the stock-replenishment need.

The machine-learning engine 150 may be configured to generate virtual sensor data based on user interactions with the edge devices 102, the distributed IIOT devices 103, and the mobile devices 116. The way in which users involved with a particular industrial process interact with the edge devices 102, the distributed IIOT devices 103, the mobile devices 116, or some combination thereof may provide information that relates to the industrial process. In some embodiments, the machine-learning engine 150 may be configured to generate virtual sensor data relating to a user involved in a particular industrial process based on the user's interactions with the edge devices 102, the distributed IIOT devices 103, the mobile devices 116, or some combination thereof.

For example, a particular mobile device may include a user interface that includes multiple different pages corresponding to different steps in a warehouse item-procurement process. In this and other examples, a delay between receiving the user's input on a first page versus on a second page may implicitly indicate how long the user takes to perform the steps of the warehouse item-procurement process associated with the first page of the user interface, and as such, the machine-learning engine 150 may generate virtual sensor data indicating a time taken to perform the steps associated with the first page of the user interface for the IIOT system 118. As another example, the machine-learning engine 150 may generate virtual sensor data of location tracking of a human user or operator in an industrial process or interactions between human users or operators based on GPS data associated with mobile devices carried by the human users or operators. The user behavior captured based on the user's interactions with the edge devices 102, the distributed IIOT devices 103, the mobile devices 116, or some combination thereof may be used to determine sensor metadata that may be generated as virtual sensor data for the IIOT system 118. As other examples, the virtual sensor data associated with users' usages of the edge devices 102, the distributed IIOT devices 103, the mobile devices 116, or some combination thereof associated with a particular industrial operation may include operational error rates of the users, time taken by users to complete an operation, identities of the users, time between completion of the industrial operations by the users, combinations thereof, and other similar user-specific behavior parameters.

In some embodiments, the generated virtual sensor data relating to the user may be paired with, appended to, or otherwise associated with other sensor data, whether physically or virtually generated. For example, the generated virtual sensor data relating to the user may be appended as one or more additional variables to other related sensor data obtained by the IIOT system 118 (e.g., from a particular edge device 102 or from a particular distributed IIOT devices 103). The virtual sensor data relating to the user may be used as metadata that further describes other sensor data obtained by the IIOT system 118 or as complementary sensor data that provides additional details about the industrial operations to which the sensor data obtained by the IIOT system 118 relates.

In these and other embodiments, formatting sensor data obtained by the IIOT system 118 into one or more common data formats may facilitate training of the machine-learning engine 150. For instance, the sensor data is prepared in one or more normalized (e.g., the common) data formats that improve comparability between the obtained sensor data. Accordingly, the sensor data may be normalized into the one or more of the common data formats by the IIOT system 118, training bias of the machine-learning engine 150 may be reduced or eliminated altogether because normalization of the obtained sensor data (i.e., training dataset for the machine-learning engine 150) may be performed autonomously by the IIOT system 118 rather than by a human user.

Modifications, additions, or omissions may be made to the IIOT system 118 and the operating environment 100 without departing from the scope of the present disclosure. For example, the designations of different elements in the manner described is meant to help explain concepts described herein and is not limiting. For instance, in some embodiments, the main API 120, the streaming API 122, the public API set 126, the private virtual host 128, the public virtual host 130, the rules engine 132, the data storage 134, the database 136, the data storage locations 138, and the web console 140 are delineated in the specific manner described to help with explaining concepts described herein but such delineation is not meant to be limiting. Further, the IIOT system 118 and the operating environment 100 may include any number of other elements or may be implemented within other systems or contexts than those described.

FIG. 3 is a flowchart of an example method 300 of processing signal data relating to IIOT devices and industrial operations according to at least one embodiment of the present disclosure. The method 300 may be performed by any suitable system, apparatus, or device. For example, the edge devices 102, the distributed IIOT devices 103, the cloud system 112, the mobile devices 116, the IIOT system 118, or another computer system such as the computer system 400 may perform one or more operations of the method 300. Although illustrated with discrete blocks, the steps and operations associated with one or more of the blocks of the method 300 may be divided into additional blocks, combined into fewer blocks, or eliminated, depending on the particular implementation.

The method 300 may begin at block 302, in which a first sensor input signal may be obtained. The first sensor input signal may include signal data obtained from one or more edge devices involved with industrial operations, such as warehouse operations relating to product retrieval, stock replenishment, or shelf reorganization. Additionally or alternatively, the first sensor input signal may be obtained from any other devices or computer, such as the mobile devices 116, the IIOT system 118, or the cloud system 112 as described in relation to FIGS. 1 and 2. Additionally or alternatively, the first sensor input signal may be virtual signal data that is similar to or the same as the signal data obtainable from edge devices or any other devices or computer systems configured to capture sensor data.

A machine learning system, for example, may generate the virtual signal data after being trained using a dataset that includes sensor data from multiple edge devices or other computer systems. Additionally or alternatively, the machine learning system training may be trained to identify one or more data inputs that are frequently correlated with or causally related to the sensor data captured by the edge devices or other computer systems. In these and other instances, the machine learning system may virtually generate the correlated or causally related data input. Additionally or alternatively, the machine learning system may generate the virtual sensor data in response to receiving the correlated or causally related data input.

At block 304, the first sensor input signal may be converted to a second sensor input signal having a common data format. Conversion of the first sensor input signal may be facilitated by a computer system, such as the IIOT system as described in relation to FIGS. 1 and 2. In some embodiments, the conversion of the first sensor input signal to the common data format may include using one or more data transformation rules, such as those involved with the rules engine 132 as described in relation to FIG. 2. In some instances, a first data transformation rule may be involved with converting the first sensor input signal to a first common data format, and a second data transformation rule may be involved with converting the first sensor input signal to a second common data format. Additionally or alternatively, a third or a fourth data transformation rule may be involved with converting the first sensor input signal to a third common data format.

At block 306, the second sensor input signal may be appended with a variable that describes information relating to the first sensor input signal. In some embodiments, the variable appended to the second sensor input signal may include sensor information obtained alongside the first sensor input signal. For example, a first sensor input signal may be an image of a warehouse shelf that shows a quantity of a product located on the warehouse shelf, and the variable appended to a corresponding second sensor input signal may include a numerical value indicating the quantity of the product. The variable may include metadata that describes the first sensor input signal obtained at block 302. For example, the variable appended to the first sensor input signal depicting the image of the warehouse shelf may include a time at which the first sensor input signal was obtained, a temperature of the warehouse at the time that the first sensor input signal was obtained, an identity of the last operating user to interact with the warehouse shelf, or any other information that may describe the first sensor input signal.

At block 308, the second sensor input signal may be broadcast to one or more data storage locations. In some embodiments, the second sensor input signal may be broadcast to one or more of the databases 136 or one or more of the data storage locations 138 of the data storage 134 as described in relation to FIG. 2. In some embodiments, one or more receiving systems may be configured to retrieve second sensor input signals stored in one or more data storage locations 138 of the data storage 134. For example, a first receiving system may be configured to retrieve sensor data from a first data storage location, a second receiving system may be configured to retrieve sensor data from a second data storage location, and a third receiving system may be configured to retrieve sensor data from the first data storage location or the second data storage location. In these and other examples, the receiving systems may be components involved with industrial operations or computer systems configured to control and actuate the components.

At block 310, an instruction to actuate warehouse operations may be sent to one or more receiving systems. In some embodiments, the instruction to actuate the warehouse operations may involve sending a control signal, a message, any other form of communication, or some combination thereof relating to one or more of the warehouse operations. For example, an instruction to actuate the warehouse operations may include a control signal to turn on a light associated with a specific warehouse shelf. As an additional example, an instruction may include a message sent to a mobile device, such as the mobile device 116, corresponding to an operating user of the warehouse operations in which the message instructs the user to move to a specific warehouse shelf or interact with a specific product located in the warehouse.

At block 312, one or more operations of a warehouse may be controlled based on the instruction to actuate the warehouse operations. In some embodiments, the operations of the warehouse may be controlled by one or more of the receiving systems to which the instruction to actuate warehouse operations were sent.

Modifications, additions, or omissions may be made to the method 300 without departing from the scope of the disclosure. For example, the designations of different elements in the manner described is meant to help explain concepts described herein and is not limiting. Further, the method 300 may include any number of other elements or may be implemented within other systems or contexts than those described.

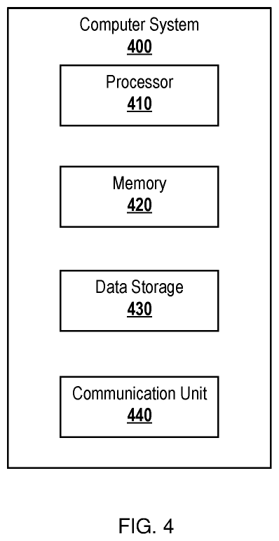

FIG. 4 is an example computer system 400, according to at least one embodiment described in the present disclosure. The computing system 400 may include a processor 410, a memory 420, a data storage 430, and a communication unit 440, which may be communicatively coupled. One or more of the components (e.g., 116, 118, 102, and 112) or portions thereof of the operating environment 100 of FIGS. 1 and 2 may be implemented as a computing system or device consistent with the computing system 400.

The processor 410 may include any suitable special-purpose or general-purpose computer, computing entity, or processing device including computer hardware or software modules and may be configured to execute instructions stored on any applicable computer-readable storage media. For example, the processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 410 may include any number of processors distributed across any number of network or physical locations that are configured to perform individually or collectively any number of operations described in the present disclosure. In some embodiments, the processor 410 may interpret and/or execute program instructions and/or process data stored in one or both of the memory 420 and the data storage 430. In some embodiments, the processor 410 may fetch program instructions from the data storage 430 and load the program instructions into the memory 420.

After the program instructions are loaded into the memory 420, the processor 410 may execute the program instructions, such as instructions to cause the computing system 400 to perform or to control one or more of the operations of the method 300 of FIG. 3. For example, the computing system 400 may execute the program instructions to obtain a first sensor input signal, convert the first sensor input signal to a second sensor input signal having a common data format, append the second sensor input signal with a variable that describes information relating to the first sensor input signal, broadcast the second sensor input signal to one or more data storage locations, send an instruction to actuate warehouse operations to one or more receiving systems, or control one or more operations of a warehouse based on the instruction to actuate the warehouse operations.

The memory 420 and the data storage 430 may include computer-readable storage media or one or more computer-readable storage mediums for having computer-executable instructions or data structures stored thereon. Such computer-readable storage media may be any available media that may be accessed by a general-purpose or special-purpose computer, such as the processor 410. In some embodiments, the computing system 400 may or may not include one or both of the memory 420 and the data storage 430.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 410 to perform a particular operation or group of operations.

The communication unit 440 may include any component, device, system, or combination thereof that is configured to send or receive information over a network such as the network 110. In some embodiments, the communication unit 440 may communicate with other devices at other locations, the same location, or even other components within the same system. For example, the communication unit 440 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a Wi-Fi device, a WiMax device, cellular communication facilities, or others), and/or the like. The communication unit 440 may permit data to be exchanged with a network and/or any other devices or systems described in the present disclosure. For example, the communication unit 440 may allow the system 400 to communicate with other systems, such as computing devices and/or other networks.

One skilled in the art, with the benefit of the present disclosure, may recognize that modifications, additions, or omissions may be made to the system 400 without departing from the scope of the present disclosure. For example, the system 400 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of industrial internet of things (IIOT) data conversion and distribution, the method comprising:
obtaining a first sensor input signal from an IIOT device;
converting the first sensor input signal to a second sensor input signal having a common data format based on one or more data conversion rules;
appending the second sensor input signal with a variable that describes information relating to the first sensor input signal;
broadcasting the second sensor input signal in the common data format to data storage locations;
sending an instruction to actuate warehouse operations to one or more receiving systems based on the one or more data storage locations to which the second sensor input signal is broadcast; and
controlling one or more operations of a warehouse based on the instruction to actuate warehouse operations.

2. The method of claim 1, wherein obtaining the first sensor input signal includes:
applying a data conversion rule of a plurality of data conversion rules to the first sensor input signal in which each data conversion rule of the plurality converts a particular sensor input signal with a corresponding data format to the common data format.

3. The method of claim 1, wherein:
a particular receiver system of the one or more receiving systems is configured to query a specific data storage location of the one or more data storage locations for the second sensor input signal, and
responsive to the second sensor input signal being included in the specific data storage location, controlling the one or more operations of the warehouse based on the second sensor input signal.

4. The method of claim 1, wherein controlling the one or more operations of the warehouse include:
monitoring behavior of one or more warehouse operators,
specifying an item to be retrieved from the warehouse,
specifying a quantity of the item to be retrieved from the warehouse, or
identifying dangerous operating conditions within the warehouse.

5. The method of claim 1, wherein obtaining the first sensor input signal includes:
receiving, by a machine-learning system, information relating to warehouse operations; and
generating, by the machine-learning system, a virtual sensor input signal responsive to the information relating to warehouse operations.

6. The method of claim 1, wherein:
the data conversion rules include a device template configured to identify one or more fields of information included in a particular first sensor input signal obtained from a particular device type; and
the device template is used to convert the first sensor input signal to the second sensor input signal.

7. The method of claim 1, further comprising obtaining warehouse operations metadata, wherein controlling the one or more operations of the warehouse is based on the instruction to actuate warehouse operations and the warehouse operations metadata.

8. The method of claim 7, wherein the warehouse operations metadata includes:
operational error rates of warehouse operators,
time taken by warehouse operators to complete operations,
identities of the warehouse operators, or
time between completion of the warehouse operations by the warehouse operators.

9. One or more non-transitory computer-readable storage media configured to store instructions that, in response to being executed, cause a system to perform industrial internet of things (IIOT) data conversion and distribution operations, the operations comprising:
obtaining a first sensor input signal from an IIOT device;
converting the first sensor input signal to a second sensor input signal having a common data format based on one or more data conversion rules;
appending the second sensor input signal with a variable that describes information relating to the first sensor input signal;
broadcasting the second sensor input signal in the common data format to one or more data storage locations;
sending an instruction to actuate warehouse operations to one or more receiving systems based on the one or more data storage locations to which the second sensor input signal is broadcast; and
controlling one or more operations of a warehouse based on the instruction to actuate warehouse operations.

10. The one or more non-transitory computer-readable storage media of claim 9, wherein obtaining the first sensor input signal includes:
applying a data conversion rule of a plurality of data conversion rules to the first sensor input signal in which each data conversion rule of the plurality converts a particular sensor input signal with a corresponding data format to the common data format.

11. The one or more non-transitory computer-readable storage media of claim 9, wherein:
a particular receiver system of the one or more receiving systems is configured to query a specific data storage location of the one or more data storages for the second sensor input signal, and
responsive to the second sensor input signal being included in the specific data storage location, controlling the one or more operations of the warehouse based on the second sensor input signal.

12. The one or more non-transitory computer-readable storage media of claim 9, wherein controlling the one or more operations of the warehouse include:
monitoring behavior of one or more warehouse operators,
specifying an item to be retrieved from the warehouse,
specifying a quantity of the item to be retrieved from the warehouse, or
identifying dangerous operating conditions within the warehouse.

13. The one or more non-transitory computer-readable storage media of claim 9, wherein obtaining the first sensor input signal includes:
receiving, by a machine-learning system, information relating to warehouse operations; and
generating, by the machine-learning system, a virtual sensor input signal responsive to the information relating to warehouse operations.

14. The one or more non-transitory computer-readable storage media of claim 9, wherein:
the data conversion rules include a device template configured to identify one or more fields of information included in a particular first sensor input signal obtained from a particular device type; and
the device template is used to convert the first sensor input signal to the second sensor input signal.

15. The one or more non-transitory computer-readable storage media of claim 9, wherein:
the operations further comprise obtaining warehouse operations metadata; and
the controlling the one or more operations of the warehouse is based on the instruction to actuate warehouse operations and the warehouse operations metadata.

16. The one or more non-transitory computer-readable storage media of claim 15, wherein the warehouse operations metadata includes:
operational error rates of warehouse operators,
time taken by warehouse operators to complete operations,
identities of the warehouse operators, or
time between completion of the warehouse operations by the warehouse operators.
